(19) United States
(12) Patent Application Publication
(10) Pub. No.: US 2001/0033268 A1
(43) Pub. Date: Oct. 25, 2001

(54) Handheld ergonomic mouse

(76) Inventor: Jiong John Jiang, Algonquin, IL (US)

Correspondence Address: Jiong John Jiang, 1320 Stonegate Road, Algonquin, IL, 60102, US

(21) Appl. No.: 09/788,097

(22) Filed: Feb. 20, 2001

Related U.S. Application Data
(60) Provisional application No. 60/185,860, filed on Feb. 29, 2000.

(51) Int. Cl. G09G 5/08

(52) U.S. Cl. 345/163; 345/173

(57) ABSTRACT

A handheld ergonomic mouse comprising a handheld unit, a base holder, and its hookup software is disclosed. The handheld unit allows users great comfort in performing browsing intensive tasks such as browsing Internet or using network computers without being restricted to his/her desk. By moving his/her thumb on the touchpad located on the handheld unit, a user can either move mouse cursor or write on the touchpad to simulate keyboard inputs. Keyboard input simulation is accomplished by a recognition component embedded in the hookup software that traces the user's thumb movements and interprets them.

### FIELD OF THE INVENTION

The present invention relates to pointing devices used in conjunction with a personal computer. Particularly this present invention relates to a pointing device that is conventionally referred to as a mouse.

### BACKGROUND OF THE INVENTION

Computers are usually equipped to use a mouse for controlling the movement of its cursor. Computer mice employ mechanical, optical or other means to control the displacement of a cursor on a computer screen. By moving the mouse across a flat surface along two axes, the cursor is proportionally moved across the computer screen. Computer mouse has been an inseparable part of personal computers and has been in wide use since its inception. However, there are reports indicating that extended or repeated use of computer mice can result in severe physical strain. This physical strain develops because, for the hand, even the smallest of postural shifts can increase or decrease stresses on the hand and fingers. The reported number of mouse over-use related injuries are increasing and in some industries the injury rates rival and even surpass those of keyboard related injuries. These injuries are collectively referred to as repetitive stress injuries (RSI).

As also quoted in U. S. Pat. No. 6,005,553, some of these stresses are caused by

1. Restriction of the movement of the index finger to the left button, which necessitates pronation of the entire forearm to accomplish.

2. Restriction of the movement by the fingers and a limitation on the range of fine control. This necessitates a shift of movement activation from the fingers to the wrist and shoulder.

3. The right button position on conventional mice doesn't allow alternative grip positions with the ring finger thereby exacerbating the strain imposed on all fingers.

Using a traditional trackball mouse is advantageous in some situations. For example, in the case of graphical design or programming, a user would demand the mouse to have relatively high pointing precision. On the other side, growing number of today's computers, including network computers, have been extensively used to browse Internet. During browsing, a user has to frequently follow hyperlinks. By clicking the mouse on the area of a hyperlink, the user will be able to retrieve and view further information indicated by the hyperlink. Performing the task of browsing Internet by following hyperlinks does not require a mouse to have as high pointing precision as in the case of other applications. Most graphical design applications, for example, require a user to point the cursor on an area as small as a character. In contrast, following hyperlinks only requires a user to place cursor over an area, usually a text string, or a button, or a picture. Ideally, during browsing the user would have sat in a repose position viewing the computer screen just as watching a TV set since the browsing process is viewing intensive. Moving a regular trackball mouse on the mouse pad or a touchpad mouse that fixed on the keyboard requires the user to move his/her arm, hand and fingers during the navigation. As mentioned earlier, it could result in excessive strain developed not only on the user's figures, but also on user's arm and hand. Using a traditional trackball mouse or touchpad fixed on the keyboard is thus not ergonomically justifiable in this particular situation.

There have been many attempts to relieve the stress of users from using a traditional trackball mouse and touchpad mouse. However, most of these efforts are focused on modifications of mice shapes. U.S. Pat. No. 6,005,553 is one of such an example where a mouse is designed with palm knobs and enlarged square ends.

There is another point device that is closely related to the traditional trackball mouse. It is the touchpad device. Touchpads are small digitizer based devices to allow a person to write or draw upon their surfaces to generate codes and signals by their controllers. The signals and codes are then to be interpreted by a computer system. One application of touchpads is to simulate a computer mouse. There are, however, physical and mechanic differences between touchpad and traditional trackball mouse. For example, touchpad inputs are recorded in absolute position while an standard mouse such as a MICROSOFT mouse or IBM PS/2 mouse provide only relative location of cursor on a display screen, that is, all trackball mouse's movements are relative to the current position of the cursor. Therefore, for a touchpad to simulate standard mouse input, a internal mouse emulation program is usually needed (U.S. Pat. No. 5,995,084).

An advantage of touchpad over the traditional trackball mouse, however, is that the touchpad can be a “writing surface” for capturing the position of a finger, pen or stylus upon the touchpad. The touchpad signals are analog signals that will be captured by the touchpad controller and translated to digital codes. The digital codes will then be transferred to a computer system through an interface. The interface may be an industry standard serial interface, an industry standard parallel interface, or a custom interface requiring special adapter circuitry within the computer system. Touchpads have applications to mobile, portable, or laptop computing systems. Touchpads have also been used as a remote control when its surface is divided into sub regions to simulate button inputs (U.S. Pat. No. 5,990,890). Other touchpad applications include being used as tools for primary human input interface. Handwritings on touchpads are interpreted to text and drawings to create commands and data to operate some personal digital assistance. The pressure of the pen or stylus upon the touchpad and whether the pen is in contact with the touchpad are used to determine formations of characters.

However, to applicant's knowledge, touchpad mice in most cases, are physically unmovable and attached to the computers. Thus these applications do not fundamentally remove the source of the strain that causes the physical stress on figures, arms and shoulders, as explained earlier. U. S. Pat. No. 5,990,890 is, however, one of the exception, in which it disclosed a touchpad can be used as a remote control devices to control TV sets, or entertainment devices.

Thus, it is the subject of this invention to provide light, handheld ergonomically shaped computer mouse that can totally alleviate the need that the user has to be restrained to the desk when performing navigating oriented tasks. The invention comprises an ergonomically shaped mouse and the method to devise a process that allows the mouse to simulate keyboard entries to accomplish navigating oriented tasks. For example, the user can sit any relax position where computer monitor is visible and hold the handheld mouse to browse Internet web site. When needed, the user can enter information such as web site's login identifier, name, and password right from the same mouse just using his/her thumb. All this overcomes the shortcomings of the traditional trackball mouse and regular touchpad attached to the computer that causes the strains on the user's shoulder, arm and figures.

The new ergonomic mouse allows a user's right thumb movement to be recognized as keyboard entries. The same method disclosed also allows the thumb movement on all commercially available touchpads to be interpreted as key entry signals without revising the design of the touchpads and their device controllers. The software adopting the principle of the disclosed method resides on the computer system. The software is called mouse hookup software. It intercepts touchpad movement signals to determine the modes between mouse input and keyboard input. In the keyboard-input mode, the software recognizes keystrokes and translates them to keyboard character entries.

When pointing precision is required, simulations of traditional trackball mice can be achieved by placing the handheld mouse in its base holder. The holder then forms the base for the handheld mouse. The mouse then will function as a traditional touchpad mouse except that can accept handwritings as keyboard entries.

To summarize, the invention replaces both keyboard and traditional mouse for any transitional personal computers, which usually require a keyboard, and a mouse to accomplish their input functions. The replacement is ergonomically justified when used in browsing oriented tasks such as browsing Internet.

### DESCRIPTION OF RELATED ARTS

U.S. Pat. No. 4,812,828 (Nishi, et al.) discloses a video display processor that is connected to a mouse or a light pen. A special processor is needed to place the pulse signals. The processor will clock the X and Y counters and processes them depending on the modes of the inputs (in mouse mode and light pen mode).

U.S. Pat. No. 5,260,697 (Barrett, et al.) discloses a digitizing tablet overlaying a display screen. The system allows for the simulation of computer input devices such as a mouse and keyboard by a pen upon the digitizing touch tablet. However, the simulations are accomplished through programs within an interface processor.

U.S. Pat. No. 5,327,161 (Logan, et al.) discloses a method to emulate mouse-input devices using a program resident within a computer system. A touchpad device has a controller generating a digital code that contains the absolute position of a pen or finger on the mouse pad. This also requires a special interface that is unique to the touchpad circuitry.

U.S. Pat. No. 5,376,946 (Mikan) describes a circuit using an EPROM to convert signals from a touch screen adhered to a computer display screen to digital codes of the industry standard computer input mouse protocols.

U.S. Pat. No. 5,543,591 (Gillespie, et al.) discloses methods for recognizing tapping, pushing, hopping and zigzagging gestures upon a conductive sensor pad that can be interpreted into cursor control motions such as clicking, double clicking, and click and drag use with computer mouse devices. Further this patent also describes the “edge motion” feature as described in U.S. Pat. No. 5,543,590 (Gillespie, et al.).

U.S. Pat. No. 5,543,588 (Bisset, et al.) discloses a device that is touchpad driven and handheld. A display screen is disposed on a first one of the major opposing aces of the enclosure and a touch-sensitive object position detector input device is disposed on a second one of the major opposing faces of the enclosure. Specially designed circuitry is also disclosed.

U.S. Pat. No. 5,995,084 (Chan, et al.) discloses a system and its methods for the detection of motions of a pointed object upon a writing surface such as a touchpad. The motion is then converted in a multiplexing analog-to-digital converter to digital codes representing the location of the pointed object and the pressures of the pointed object upon the touchpad. The system and methods, again, need a special driver circuitry and the information of the absolute locations of the pointer.

U.S. Pat. No. 5,990,890 (Etheredge, 1999) disclosed a system for data entry and navigation in a user interface. The method and apparatus for quick access to menu and selection items of a user interface using an input device having limited capability. Focused on a remote control to interact with onscreen symbols menus and submenus.

U. S. Pat. No. 5,189,403 disclosed a method regarding an integrated pointing device coupled to a pointing key. It specifically address the method that allow a computer user to type and to point without removing the hands from the home row of the keyboard, and without dramatically changing the physical activity.

The following is regarding to the invention of a better ergonomic mouse.

U. S. Pat. No. 6,005,553 provided an improved ergonomic computer mouse. The ergonomic mouse allows for the operator's hand to remain in a relaxed position in as near a state of repose as possible while operating the mouse. The shape of the mouse reduces several of the known high-risk postures during mouse use.

### SUMMARY OF THE INVENTION

An ergonomic handheld computer mouse with a base holder and its hookup software that converts signals not unique to any traditional touchpad mouse is disclosed. The invention has all the functionality of both traditional mouse and keyboard. The handheld feature allows user to sit in a reposed position during the use. This alleviates the physical constraints placed on traditional keyboards and mice and provides great comfort when performing browsing and viewing intensive computer tasks such as browsing Internet.

Another object of this invention is a method of interpretation of regular mouse movements and recognizing them as handwritten keyboard inputs. This altogether alleviates any special circuitry required in all previously disclosed inventions when the touchpad signals are used as keyboard input simulation.

Furthermore, another object of this invention is to provide a mouse holder, if required. When combined with the handheld unit, it allows simulation of a normal touchpad mouse environment.

Still, another object of this invention is to detect the changing of input modes between the mouse input and the keyboard input using purely handwritten recognition instead of using a physical switch.

Further still, another object of this invention is to provide users the capability of customizing the handwritten recognition environment.

Last, another object of this invention is to recognize the sequence of handwritten strokes being part of the input signals to provide more accurate and efficient handwritten recognition.

### BRIEF DESCRIPTION OF DRAWINGS

FIG. 1 illustrates the ergonomic shape of the elliptical mouse in the top view. The shape does not have to be symmetrically in geometric sense. A small variation around the contours of the mouse may allow great conform of griping. The size illustrated in the drawing is for illustration purpose although it is close to the real size of the mouse.

FIG. 2 illustrates the ergonomic shape of the elliptical mouse in the side view.

FIG. 3 illustrates the ergonomic shape of the elliptical mouse in the bottom view.

FIG. 4 is the signal flow block diagram of a computer system employing the handheld touchpad mouse.

FIG. 5 is the block diagram of the software for the computer system to show the scope of the hookup software disclosed in the invention.

FIG. 6 illustrates the signal flow between the mouse-input mode and the keyboard-input mode.

FIG. 7 illustrates the signal flow between the keyboard-input mode and the mouse-input mode.

### DESCRIPTION OF PREFERRED EMBODIMENT

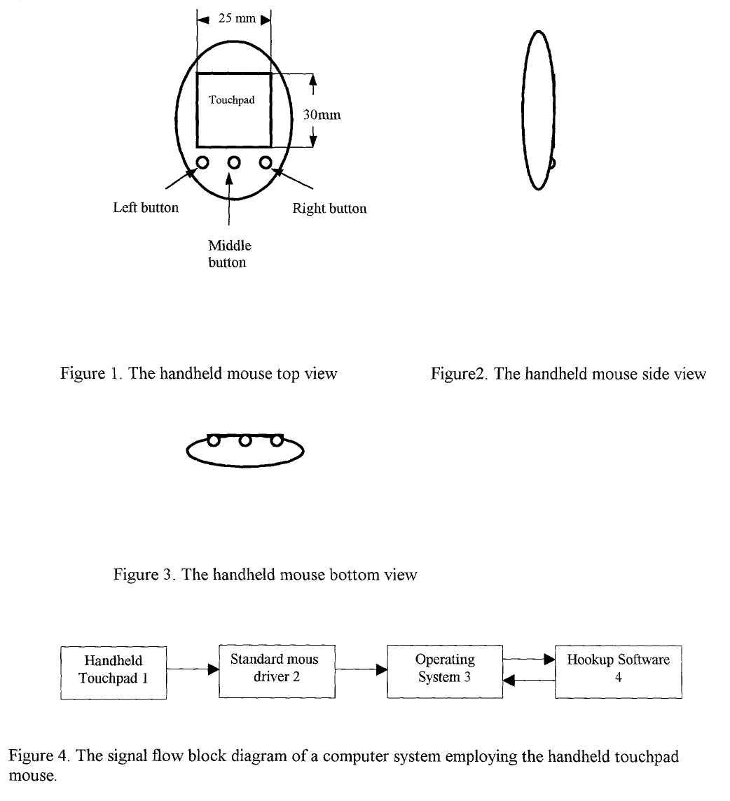

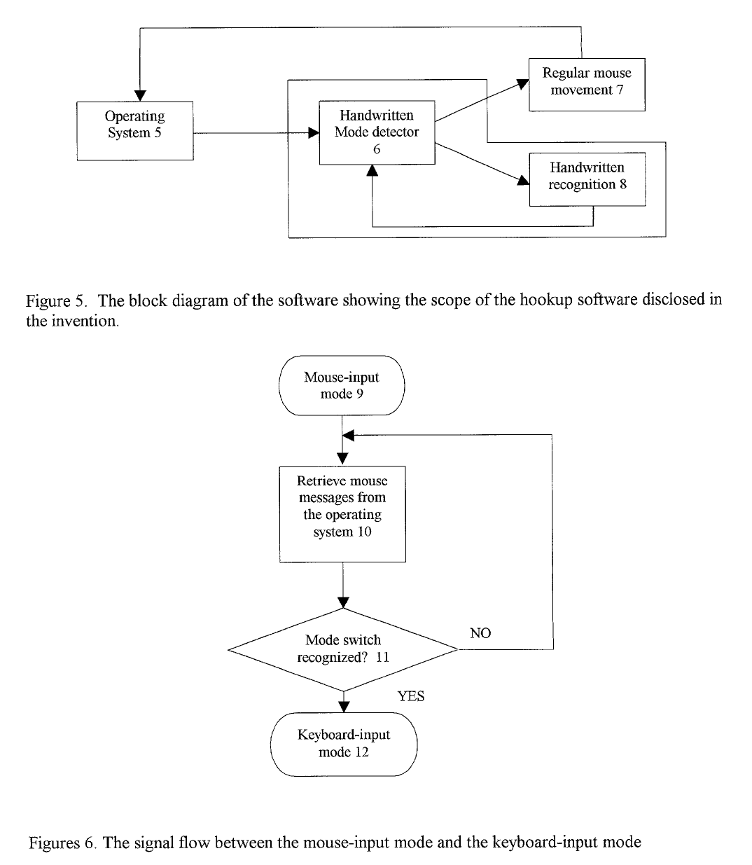

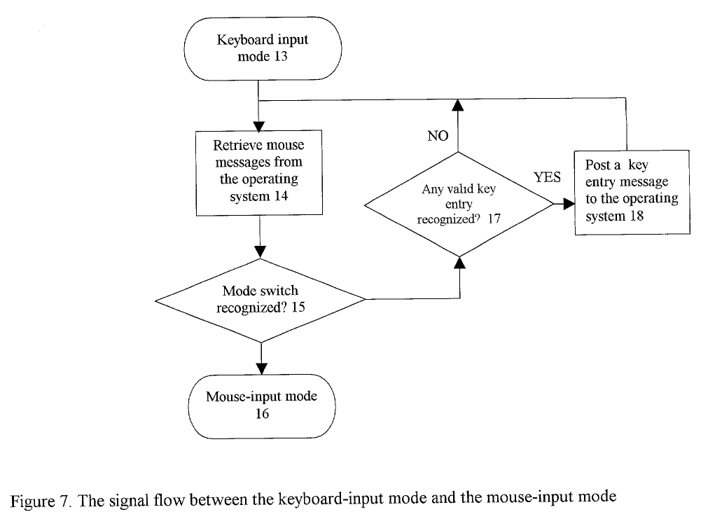

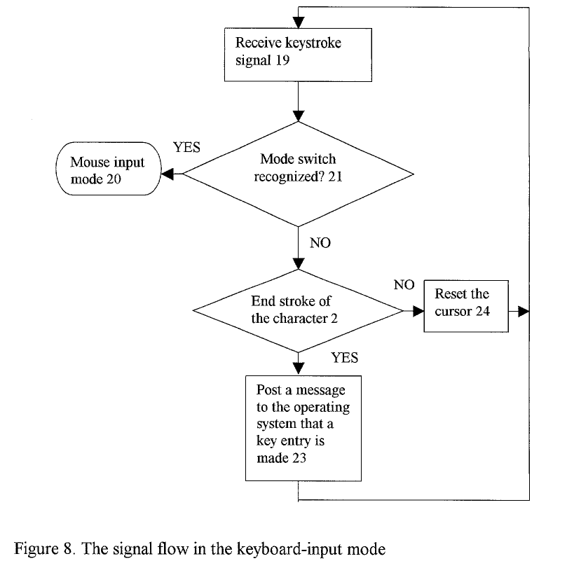

A regular standard touchpad is attached on the top of the said shaped objects (FIG. 1 - FIG. 3). The input signals are fed into computer either wired or remotely through standard mouse protocols such as Microsoft corporation's MS mouse standard, or International Business machines' Incorporated PS/2 mouse standard, or the Apple computer, Inc.'s Apple Desktop Bus or any other applicable computer input mouse protocols.

Handheld touchpad 1 is typically operated with a conductive device such as a stylus or finger. Handheld touchpad I can be either a relative or an absolute cursor movement device used in microcomputer systems. Handheld touchpad Mouse 1 has buttons to simulate regular trackball mouse buttons for accomplishing mouse-controlled functions. Two and three buttons are used. The second and third buttons have assigned functions chosen by the manufacturer. The nature of mice and the mice button(s) are well known to those skilled in the art.

Touchpad signals generated by the standard mouse driver 2 are then picked up by the operating system 3, usually a windows based operating system such as Microsoft Window 9X. Since Window 9X is a very popular operating system, we will use it as our preferred embodiment in the following disclosure.

A windows-based application receives mouse inputs in the form of messages that are sent or posted to its windows by the operating system 3. When a user moves the mouse, the operating system 3 moves a bitmap on the screen called the mouse cursor. The mouse cursor contains a single-pixel point called the hot spot, a point that the operating system 3 tracks and recognizes as the position of the cursor. When a mouse event occurs, for example, corresponding to the user's click on one of its button, the window that contains the hot spot typically receives the mouse message resulting from the event from the operating system 3. The window needs not be active or have the keyboard focus to receive a mouse message. The examples of mouse events include mouse move signals, button clicked, or button double clicked signals. The nature of mouse events and the standard mouse messages are known to those skilled in the art.

Mouse messages are divided into two groups: client area messages and non-client area messages. Typically, a window application processes client area messages and ignores non-client area messages (messages other than client area messages). A window receives a client area mouse message when a mouse event occurs within the window's client area. For example, the operating system 3 posts a WM_MOUSEMOVE message to the window when the user moves the cursor within the client area. Window also provides parameters associated with the message when a mouse event occurs. These parameters include the position of the cursor (hot spot) that is the x-coordinate of the hot spot and the y-coordinate. The coordinates are given in client coordinates. In the client coordinate system, all points on the screen are given relative to the coordinates (0,0) of the upper left corner of the client area.

A window receives a non-client area mouse message when a mouse event occurs in any part of a window except the client area. A window's non-client area consists of its border, menu bar, title bar, scroll bar, System menu (also called the Control menu), Minimize button, and Maximize button.

Windows generates non-client area messages primarily for its own use. For example, Windows uses non-client area messages to change the cursor to a two-headed arrow when the cursor hot spot moves into a window's border. A window must pass non-client area mouse messages to the DefWindowProc function to take advantage of the built-in mouse interface found in the windows.

Also there is a corresponding non-client area mouse message for each client area mouse message. The names of these messages are similar except that the named constants for the non-client area messages include the letters NC. For example, moving the cursor in the non-client area generates a WM_NCMOUSEMOVE message, and pressing the left mouse button while the cursor is in the non-client area generates a WM_NCLBUTTNDOWN message. The IParam parameter of a nonclient area mouse message is a POINTS structure that contains the x- and y-coordinates of the cursor hot spot. Unlike coordinates of client area mouse messages, the coordinates are given in screen coordinates rather than client coordinates. In the screen coordinate system, all points on the screen are relative to the coordinates (0,0) of the upper left corner of the screen.

To summarize, a window applications is capable of receiving messages regarding all mouse events occurred.

The method disclosed uses a Microsoft window technology called Window Hook (see Steven Holzner 1997), specifically Mouse and Keyboard Hooks and Journal Hooks. Journal Hooks allow the disclosed hookup software 4 read and playback system inputs including keyboard and mouse movements. The hookup software 4 using the Journal Hooks can peek into all mouse events occurred and process them according to mouse's movements on the touchpad. The hookup software 4 comprises two major components, the handwritten mode detector 6 and the handwritten character recognition component 8. The handwritten mode detector 6 tracks all mouse movements directed to window applications to detect a mode switch maneuver. The mode switch maneuver can be any meaningful movement such as quick back and forth movements of a user's thumb on the touchpad. The mode switch maneuver can also be drawing of a circle, or point click on an area designated on the windows screen, as seen fit by the user. The user can customize the maneuver in the setting of the software. Once such maneuver or action is taken by the user on the touchpad 1, it deems to cause mode changes between the mouse-input mode 9, 16 and keyboard-input mode 12, 13. In the mouse-input mode, all standard mouse inputs are recognized by window applications. The touchpad is acting as a regular touchpad mouse except that all mouse movements are tracked and watched by the hookup software's mode detector 6 running in the background. The mode change detector tracks user's thumb movements to detect if there is a mode switch maneuver when in the mouse-input mode 9. Once the mode switch is detected, the software will then switch to the input mode to simulate keyboard entries, all mouse movements thereafter are keyboard entry simulations until the next switch maneuver is detected. Note the switch maneuver from the mouse-input mode to the keyboard-input mode do not have to be the same. In the keyboard-input mode, all thumb movements will be interpreted as keystroke signals and sent to handwritten recognition component 10. The recognition component 10 then interprets thumb movements as keystrokes using recognition mechanism which constructs sequences of keystroke signals captured and compares them to the characters stored in a character bank. The handwritten component 10 knows whether the current thumb stroke is the end stroke of a specific character by an embedded sequence recognition mechanism. Once it recognizes the stroke is the end stroke of a specific character, it will then post a keyboard character entry messages to the operating system 5. The recognizable keys can include all key characters on the standard keyboard (alpha numeric, function keys). User can also map these keys into different strokes for better and more efficient recognition performance. To further facilitate the recognition process without absolute mouse location information, the cursor's position is reset to the middle of the screen after each keystroke in the keyboard-input mode. This avoids the situation when the cursor is outside the screen range. A bitmap illustrating the character recognized in progress can also be displayed when necessary.

Note that the software used to recognize handwritten (or thumb movements) as the keyboard entry signal does not form any part of the said claims. One of such recognition software is built using Intel Primitive Recognition Library. However, the method disclosed as claimed that uses sequence information of keystrokes as inputs to the handwritten software component 10 is an integral part of the invention.

Having illustrated and described the principles of the invention in a preferred embodiment thereof, it should be readily apparent to those skilled in the art that the invention can be modified in arrangement and detail without departing from such principles. In particular, but without limitation, allocation of functions between hardware and software is subject to wide variation depending on system platforms. We claim all modifications coming within the sprit and scope of the accompanying claims.

1. A computer mouse for manipulating by the right hand of a user to control the operation of a computer, comprising a handheld unit, a base holder and its hookup software. The handheld unit is operated solely by a user's right thumb when handheld. When the handheld unit is placed on the base holder, it can function as a regular touchpad mouse. The mouse can simulate keyboard inputs when the user touches on the touchpad surface on the top of the said handheld unit, by right thumb when handheld;

2. The handheld unit of claim 1 further comprises a touchpad, a housing holder and mouse buttons;

3. The handheld unit of claim 1 is small enough to be held in a user's right hand in grasping grip;

4. The handheld unit of claim 1 is of elliptic shape (FIG. 1);

5. The handheld unit of claim 1 is of credit card shape;

6. The handheld unit of claim 1 can be operated solely by a user's right thumb;

7. The handheld unit of claim 1 can have small flat or intruded buttons, located in front of the said touchpad;

8. The handheld unit of claim 1 is connected to its computer through a regular cable;

9. The handheld unit of claim 1 is connected remotely to its computer, through RF signals and IR signals;

10. The method that the hookup software works as an interpreter between the said touchpad input signals and the connected computer's operating system. The software intercepts the signals and recognizes them either as regular mouse signals or keystroke signals;

11. The method that the hookup software processes handwriting stroke's information without the knowledge of absolute location of thumb movement on the said touchpad;

12. The method that the additional part of the mouse, the base holder unit, is separated from the core movable part, the handheld unit, allowing the flexibility of either being used as handheld or as a regular touchpad mouse;

13. The method that uses the sequence of handwritten stroke information as inputs to the recognition software component.
